(19) United States
(12) Patent Application Publication
(10) Pub. No.: US 2024/0231567 A1
(43) Pub. Date: Jul. 11, 2024

(54) METHOD, APPARATUS AND ELECTRONIC DEVICE FOR SESSION MENU PROCESSING

(71) Applicant: Beijing Zitiao Network Technology Co., Ltd., Beijing (CN)

(72) Inventors: Guoxing CUI, Beijing (CN); Liyang Zhou, Beijing (CN); Lu Wang, Beijing (CN); Zhendong Jiang, Beijing (CN); Ziqing Zhou, Beijing (CN); Bo Li, Beijing (CN)

(21) Appl. No.: 18/614,327

(22) Filed: Mar. 22, 2024

(30) Foreign Application Priority Data
Mar. 22, 2023 (CN) 202310286365.4

(51) Int. Cl. G06F 3/0482; H04L 51/02

(52) U.S. Cl. CPC G06F 3/0482; H04L 51/02

(57) ABSTRACT

This disclosure provides a method, apparatus and electronic device for session menu processing. The method comprises: in response to a predetermined operation triggered by a first user on a user interface of a target session, creating a session menu in the target session; and in response to a triggering operation on the created session menu by the second user, performing an execution step corresponding to the session menu, wherein the first and second users are both session members of the target session, and the second user and the first user are different users or the same user. There are provided more convenience for communications between session members, more flexibility of session menu operations, expanded session functionalities and enhanced user experience.

### CROSS REFERENCE

The present application claims priority to Chinese patent application Ser. No. 20/231,0286365.4 filed on Mar. 22, 2023, and entitled “METHOD, APPARATUS AND ELECTRONIC DEVICE FOR SESSION MENU PROCESSING”, the entirety of which is incorporated herein by reference.

### FIELD

The present disclosure relates to the field of computer, and specifically, to a method, apparatus and electronic device for session menu processing.

### BACKGROUND

With the continuous development of terminal technology and network technology, instant messaging tools are increasingly used in people's lives and work. People can communicate with friends or group members in sessions of instant messaging tools. Currently, members in a session can process business-related transactions by use of the session menu. For example, the session menu in some specific sessions includes: a menu item for appointment registration, a menu items for query of results, etc. However, these session menus are usually fixed and configured by developers, and users cannot create session menus on their own.

### SUMMARY

The present disclosure provides a method, apparatus and electronic device for session menu processing.

According to a first aspect, there is provided a method for session menu processing. The method comprises: in response to a predetermined operation triggered by a first user on a user interface of a target session, creating a session menu in the target session; in response to a triggering operation on the created session menu by the second user, performing an execution step corresponding to the session menu; wherein the first and second users are both session members of the target session, and the second user and the first user are different users or the same user.

According to a second aspect, there is provided an apparatus for session menu processing. The apparatus comprises: a first creation module configured to, in response to a predetermined operation triggered by a first user on a user interface of a target session, create a session menu in the target session; a first execution module configured to, in response to a triggering operation on the created session menu by the second user, perform an execution step corresponding to the session menu; wherein the first and second users are both session members of the target session, and the second user and the first user are different users or the same user.

According to a third aspect, there is provided a computer-readable storage medium storing a computer program thereon, the computer program, when executed in a computer, causing the computer to perform the method of any of the first aspect.

According to a fourth aspect, there is provided an electronic device comprising a memory, a processor, and a computer program stored in the memory and executable by the processor. The processor, when executing the program, implements the method of any of the first aspect.

The technical solutions provided by embodiments of the present disclosure can provide the following beneficial effects.

Embodiments of the present disclosure provide a method and apparatus for session menu processing. By creating a session menu in a target session by session members of the target session, any session member can perform the execution steps corresponding to the session menu through the session menu. This facilitates communications between session members. Also, the flexibility of use of the session menu is provided, functionalities of the session are expanded, and the user experience is enhanced.

It should be understood that the foregoing general description and the following detailed description are example and explanatory only, and do not limit the present disclosure.

### BRIEF DESCRIPTION OF THE DRAWINGS

In order to more clearly illustrate the technical solutions of the embodiments in this specification, the drawings required for the description of the embodiments will be briefly introduced below. Obviously, the drawings in the following description are only some of the embodiments recorded in this specification. For this purpose For those of ordinary skill in the art, other drawings can be obtained based on these drawings without exerting any creative effort.

FIG. 1 is a schematic diagram of an example system architecture in which embodiments of the present disclosure can be implemented;

FIG. 2 is a flowchart illustrating a method for session menu processing according to an example embodiment of the present disclosure;

FIG. 3A is a schematic diagram illustrating a scenario of session menu processing according to an example embodiment of the present disclosure;

FIG. 3B is a schematic diagram illustrating another scenario of session menu processing shown according to an example embodiment of the present disclosure;

FIG. 3C is a schematic diagram illustrating another scenario of session menu processing according to an example embodiment of the present disclosure;

FIG. 3D is a schematic diagram illustrating another scenario of session menu processing according to an example embodiment of the present disclosure;

FIG. 4 is a flowchart illustrating another method for session menu processing according to an example embodiment of the present disclosure;

FIG. 5 is an interactive flowchart illustrating a method for session menu processing according to an example embodiment of the present disclosure;

FIG. 6 a block diagram illustrating an apparatus for session menu processing according to an example embodiment of the present disclosure;

FIG. 7 is a schematic block diagram illustrating an electronic device provided by some embodiments of the present disclosure;

FIG. 8 is a schematic block diagram illustrating another electronic device provided by some embodiments of the present disclosure; and

FIG. 9 is a schematic diagram illustrating a storage medium provided by some embodiments of the present disclosure.

### DETAILED DESCRIPTION

In order to enable the personnel of this FIELD to better understand the technical solutions in this specification, the technical solutions in the embodiments in this specification will be clearly and completely described below in conjunction with the accompanying drawings in the embodiments of this specification. Obviously, the described embodiments are only This manual contains some, not all, of the embodiments. Based on the embodies in this specification, all other embodies obtained by those of ordinary skill in the art without creative work should fall within the scope of protection of this specification.

When the following description refers to the drawings, the same numbers in different drawings refer to the same or similar elements unless otherwise indicated. The embodiments described in the following example embodiments do not represent all embodiments consistent with the present disclosure. Rather, they are merely examples of apparatus and methods consistent with aspects of the present disclosure as detailed in the accompanying claims.

The terminology used in this disclosure is for the purpose of describing particular embodiments only and is not intended to be limiting of the disclosure. As used in this disclosure, the singular forms “a,” “the” and “the” are intended to include the plural forms as well, unless the context clearly dictates otherwise. It will also be understood that the term “and/or” as used herein refers to and includes any and all possible combinations of one or more of the associated listed items.

It should be understood that although the terms first, second, third, etc. may be used in this disclosure to describe various information, the information should not be limited to these terms. These terms are only used to distinguish information of the same type from each other. For example, without departing from the scope of the present disclosure, the first information may also be called the second information, and similarly, the second information may also be called the first information. Depending on the context, the word “if” as used herein may be interpreted as “when” or “when” or “in response to determining.”

FIG. 1 is a schematic diagram of an example system architecture where embodiments of the present disclosure can be applied.

As shown in FIG. 1, the system architecture 100 may include terminal devices 101, 102, a network 103 and a server 104. It should be understood that the number or types of terminal devices, networks and servers in FIG. 1 are only illustrative. It is possible to have any number or type of terminal devices, networks, and servers depending on the implementation requirements.

The network 103 is a medium used to provide communication links between terminal devices and servers. Network 103 may include various connection types, such as wired, wireless communication links, or fiber optic cables, among others.

The terminal devices 101 and 102 can interact with the server through the network 103 to receive or send requests or information, etc. The terminal devices 101 and 102 may be various electronic devices, including but not limited to smartphones, tablet computers, smart wearable devices, personal digital assistants, and so on.

The server 104 can store, analyze and process the received data, and can also send control commands or requests to the terminal device or other servers. The server can provide services in response to users' service requests. It can be understood that one server can provide one or more services, and the same service can also be provided by multiple servers.

Based on the system architecture shown in FIG. 1, in embodiments of the present disclosure, the terminal device 101 or the terminal device 102, after determining that the user triggers a predetermined operation on the user interface of the target session, can send to the server 104 through the network 103 information that triggers the predetermined operation. After receiving such information, the server 104 can instruct the terminal device corresponding to some or all members of the target session, to a session menu in the target session. As such, members in the target session are allowed to execute the execution steps corresponding to the session menu based on the created session menu. The present disclosure will be described in detail below with reference to some embodiments.

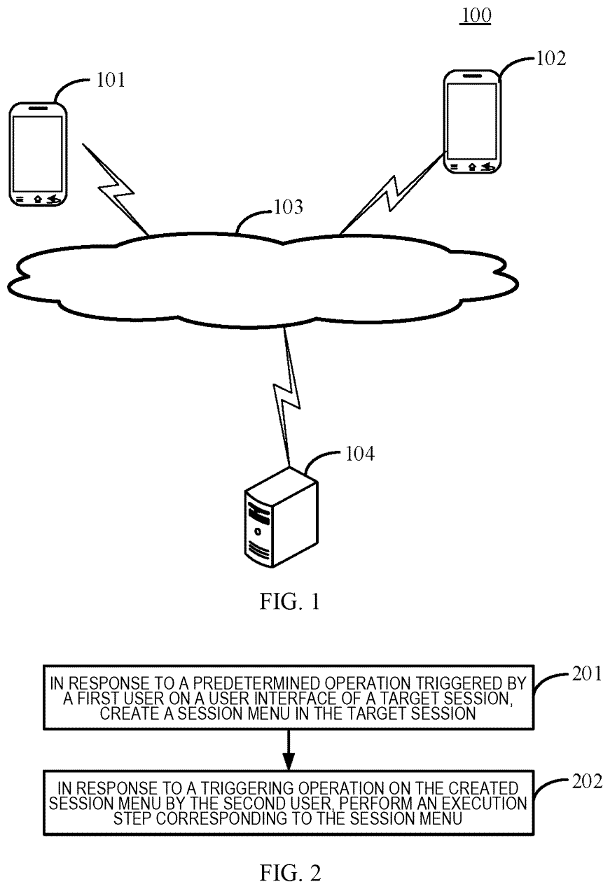

FIG. 2 is a flowchart of a method for session menu processing according to an example embodiment. This method can be implemented as any terminal device, platform, server or device cluster with computing and processing capabilities. The method can comprise the following steps.

As shown in FIG. 2, at step 201, in response to a predetermined operation triggered by a first user on a user interface of the target session, a session menu is created in the target session.

In this embodiment, the target session can be window for a window for transmitting instant messages between users in an instant messaging client. The target session can be a single chat session between two users or a group chat among a plurality of users. After logging in to the instant messaging client, users can send messages to friends/group members in the target session. A first user is a session member of the target session. The first user can be the administrator of the target session, a member designated by the administrator of the target session, or any ordinary member of the target session. It is to be understood that the specific identity of the first user in the target session is not limited.

At step 202, in response to a triggering operation by a second user for the created session menu, an execution step corresponding to the session menu is performed.

In this embodiment, the second user is also a session member of the target session. The second user and the first user can be different users or the same user. After the second user triggers the created session menu, the execution step(s) corresponding to the session menu can be performed. The execution step corresponding to the session menu can be a step of performing information statistics or sharing information in the session. For example, if the session menu is a session menu for team building registration, after the second user triggers the session menu, a page for team building registration can be displayed, the second user can enter team building registration information through this page. As another example, if the session menu is a session menu for testing demonstration, after the second user triggers the session menu, a page for testing demonstration can be displayed, and the second user can conduct test demonstration through this page. As yet another example, if the session menu is a session menu for voting, after the second user triggers the session menu, a page for voting can be displayed, and the second user can vote through this page.

By the method shown in FIG. 2, the user can create a menu independently in the session, which facilitates the user's use of the session menu.

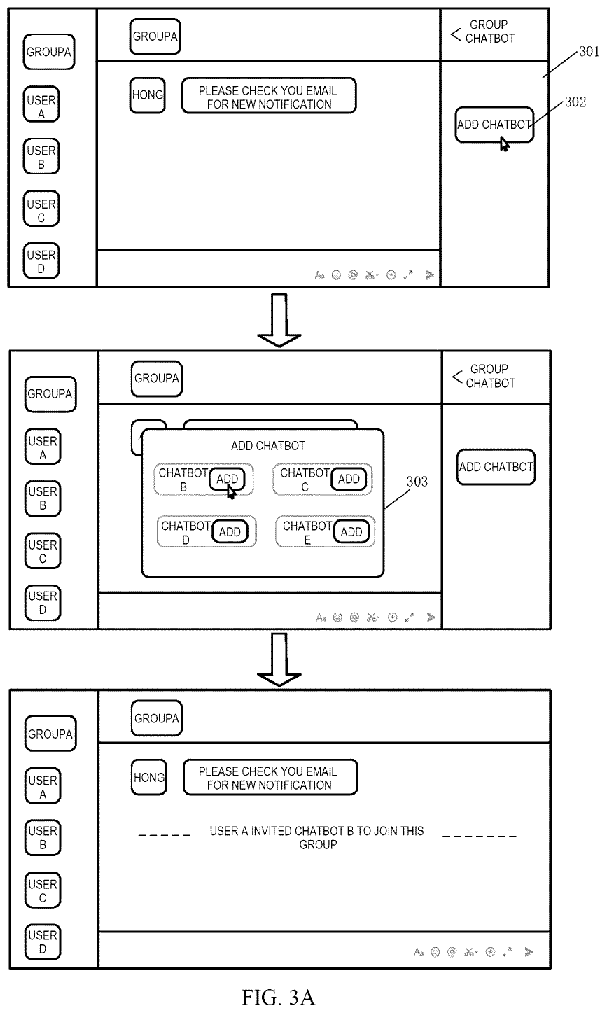

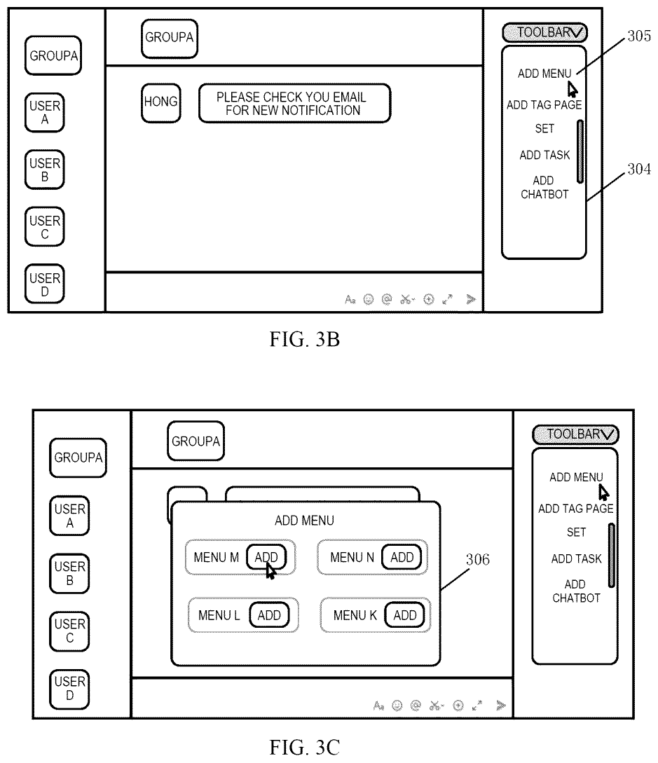

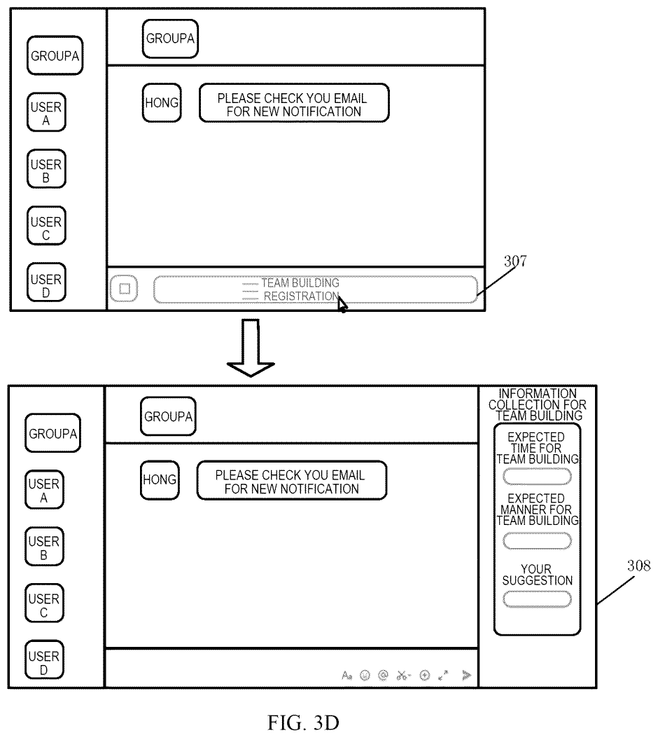

In one implementation, the predetermined operation triggered by the first user on the user interface of the target session may be an operation by the first user of adding a predetermined application associated with the session menu to the target session. For example, the predetermined application can be a predetermined chatbot, and adding the predetermined application to the target session can be adding the predetermined chatbot as a member of the target session. As shown in FIG. 3A, user a can enter chatbot selection interface 303 by triggering the robot addition control 302 in the setting area 301. The chatbot selection interface 303 shows a variety of chatbots with different functions. A user A can select the chatbot B associated with the session menu, and chatbot B is added as a member of the target session. After the addition is completed, the message “User A invited chatbot B to join this group” is displayed on the session interface of the target session of user A, and the message “User A invited chatbot B to join this group” is also displayed on the session interface of other members of the target session. The user A can be the administrator of the target session, or a member specified by the administrator of the target session, or any ordinary member of the target session.

In another implementation, the predetermined operation triggered by the first user on the user interface of the target session can be an operation by the first user for triggering a predetermined control associated with the session menu in the target session. For example, as shown in FIG. 3B, the user A can create a session menu in the target session by triggering the menu adding control 305 associated with the session menu in the toolbar 304.

In some embodiments, the predetermined operations can have corresponding objects, and different corresponding objects can correspond to different session menus. In one embodiment, if the predetermined operation is adding a predetermined chatbot as a member of the target session, the different corresponding objects may be different chatbots, and each chatbot may correspond to a kind of session menu. For example, the chatbot B corresponds to a session menu for team building registration, and a chatbot C corresponds to a menu for conducting test demonstrations, and so on.

In another embodiment, if the above predetermined operation is an operation triggering a predetermined control in the target session, then the different corresponding objects may be different predetermined controls, and each predetermined control may correspond to a kind of session menu. For example, as shown in FIG. 3C, the user A can enter a session menu selection interface 306 by triggering a predetermined control in the toolbar. The session menu selection interface 306 displays a variety of controls corresponding to different session menus. The user A can trigger a control M corresponding to session menu for team building registration, so that a session menu for team building registration can be created in the target session. Different session menus may include different menu items, and different menu items may correspond to different business functions. The business functions corresponding to the menu items are not limited in this disclosure.

In one embodiment of the present disclosure, the session menu may be an input box menu. That is, the menu is located at a session input box, and the user switches between the session entry and exit box and the session menu by a switching control.

Creating a session menu in the target session can display the session menu in the session interface of each session member of the target session, and each session member can perform the corresponding execution step of the session menu by triggering the session menu. For example, as shown in FIG. 3D, after the user A creates a session menu in the target session, each session member of the target session can use the predetermined switching operation to switch the message input box in the session interface of the target session to the session menu 307. Each session member can trigger the session menu 307 and enter the page 308 corresponding to the session menu. The page corresponding to the session menu can be displayed in the session sidebar, as shown in FIG. 3D. It is also possible to jump to a browser for display or use a pop-up window for display. No limitation is suggested in this regard.

It is to be noted that if the above predetermined operation is an operation of adding a predetermined chatbot as a member of the target session, then after this predetermined chatbot is removed from the target session by any member in the target session, the session menu can be deleted from the target session. It is to be noted that each member of the target session can perform a triggering operation for the created session menu to cause his logged-in terminal device to execute an execution step corresponding to the session menu.

In some embodiments of the present disclosure, the method as shown in FIG. 2 may further comprise: after a third user adds the above-mentioned predetermined chatbot as a member of a further session other than the target session, creating a session menu in the further session. After a fourth user triggers the created session menu, an execution step corresponding to the session menu is performed. The third user and the fourth user may be session members of the further session, and the third user and the fourth user may be different users or the same user. The session menu created in the further session is different from the menu created in the target session.

The present disclosure provides a method for processing session menus. By creating a session menu in the target session by the session members of the target session, any session member can perform an execution steps corresponding to the session menu through the session menu. More convenience for communication between session members is thus provided, the flexibility of session menu operations is improved, the functionalities of the session is expanded, and the user experience is enhanced.

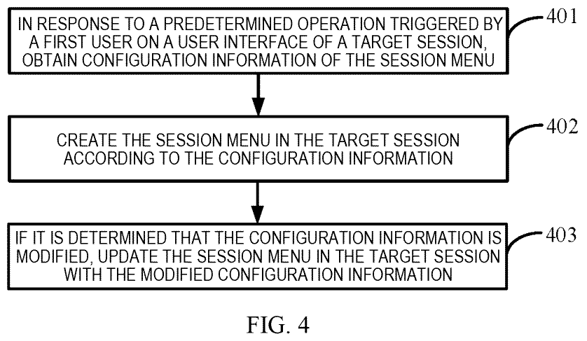

FIG. 4 is a flowchart of another method for session menu processing according to an example embodiment. The embodiment describes a process of creating a session menu, including the following steps.

As shown in FIG. 4, at step 401, in response to a predetermined operation triggered by a first user on a user interface of a target session, configuration information of the session menu is obtained. At step 402, the session menu is created in the target session according to the configuration information.

In this embodiment, the configuration information of the session menu may include, but is not limited to, a link address corresponding to the session menu, a display style corresponding to the session menu, the permission information corresponding to the session menu, and so on. The link address corresponding to the session menu can be an address linked to the page corresponding to the session menu. The link address corresponding to the session menu can be used to open the functional page corresponding to the session menu. For example, if the menu is a menu for collecting team building information, the link address is an address of a page for entering the team building information. The configuration information of the session menu can be stored in the database or in the terminal device (for example, after installing or logging in to the instant messaging client, the terminal device can retrieve the configuration information of the session menu from the database obtain for storage).

In some embodiments, the predetermined operations have corresponding objects, and different corresponding objects correspond to different session menus. For example, if the predetermined operation is adding a predetermined chatbot as a member of the target session, the different corresponding objects can be different chatbots, and each chatbot can correspond to a session menu. For another example, if the predetermined operation is an operation triggering a predetermined control in the target session, then different corresponding objects may be different predetermined controls, and each predetermined control may correspond to a type of session menu. Therefore, the corresponding object corresponding to the predetermined operation can be determined based on the predetermined operation, and then the configuration information of the session menu corresponding to the corresponding object can be obtained.

In some embodiments, the database stores at least one first information set (for example, an online datasheet), and each first information set corresponds to a corresponding object (for example, each online datasheet corresponds to a chatbot), and the configuration information of the session menu is saved in the first information set. The first information set may include correspondences between a plurality of sessions and a plurality of pieces of session menu configuration information.

In one embodiment, after the user performs the predetermined operation, the terminal device can transmit the identifier of the corresponding object corresponding to the predetermined operation to the workflow execution module of the server. Here the workflow execution module refers to a business module that executes the methods of the present disclosure. The workflow execution module can determine the first information set associated with the corresponding object based on the identification of the corresponding object and obtain the configuration information of the session menu from the first information set. Then, the workflow execution module can create a session menu based on the configuration information of the session menu and send it to the clients logged in by the members of the target session so that the clients outputs the session menu in the target session.

In one embodiment of the present disclosure, the workflow execution module can be created and run using an integration platform. The integration platform is an application integration platform that provides a visual way to orchestrate the processes of human, financial, and event business systems. It can help enterprises achieve global data interoperability and reduce the complexity and cost of enterprise internal system integration.

In another embodiment, after a predetermined operation is triggered in a user interface of any of the a plurality of sessions, the first information set can be determined according to the corresponding object of the predetermined operation. Then the session menu is created in the session based on the session menu configuration information corresponding to that session in the first information set.

At step 403, if it is determined that the configuration information is modified, the session menu in the target session is updated with the modified configuration information.

In this embodiment, the configuration information of the session menu is allowed to be modified. If the configuration information of the session menu is modified, the session menu in the target session can be updated with the modified configuration information. Specifically, if the configuration information of the session menu is modified, the database can store the modified configuration information. In one embodiment, the workflow execution module can directly update the session menu after obtaining the modified configuration information, and instruct the terminal devices logged in by the members of the target session to update the session menu in the target session. In another embodiment, the server can periodically obtain the configuration information of the session menu from and compare the newly obtained configuration information of the session menu with the previously obtained configuration information of the session menu. If it is determined based on the comparison that the configuration information of the session menu has been modified, the session menu in the target session is updated with the modified configuration information. Then, the terminal devices logged in by the members of the target session are caused to update the session menu in the target session.

In some embodiments, after creating the session menu, the first user who created the session menu can use a configuration operation to configure at least one configuration information item in the configuration information corresponding to the session menu. Further, a user from the session members of the target session who has the authority to update the first information set can set at least one configuration item in the configuration information corresponding to the session menu. The configuration operation may be a predetermined triggering operation of the user for the created session menu in the target session. Configuration items in the configuration information may include, but are not limited to, the menu name of the session menu, the link address of the session menu, the image of the session menu, the permission information of the session menu, the display style of the session menu, and so on.

In one embodiment, when creating the session menu of the target session, it is possible to first add the configuration record corresponding to the target session in the online datasheet stored in the database. The configuration record may include the default value of at least one configuration item in the configuration information corresponding to the session menu. After creating the session menu of the target session, the user can set any configuration items in the configuration information of the session menu through the configuration record corresponding to the target session in the online datasheet, thereby updating the session menu.

In this embodiment, after the session members of the target session create the session menu in the target session, the session menu can be updated through the configuration information of the session menu. This further improves the flexibility of using the session menu, expands the functionality of the session, and enhances the user experience.

It is to be noted that although in the above embodiments, the operations of the method of the disclosed embodiments are described in a specific order, this does not require or imply that these operations must be performed in the specific order, or that all the operations shown must be performed to achieve desired result. Instead, the steps depicted in a flowchart can be executed in a different order. Alternatively, or in addition, certain steps can be omitted, two or more steps may be combined into one step for execution, and/or one step may be broken down into multiple steps for execution.

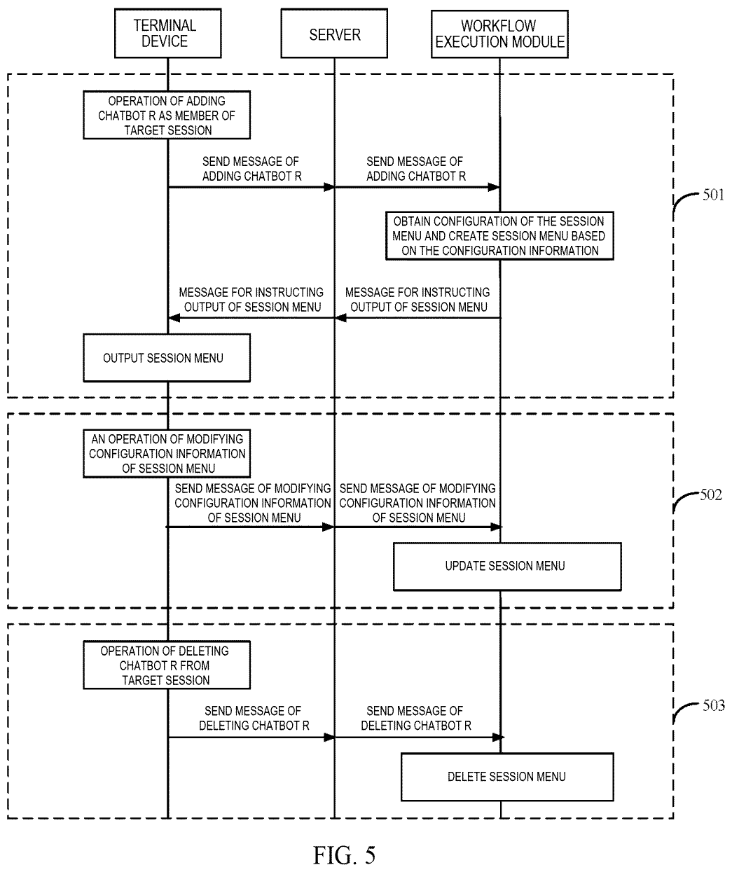

FIG. 5 is an interactive flowchart of a method for session menu processing based on an example embodiment. The solution of the present disclosure will be schematically explained with reference to FIG. 5 and a complete and specific application example.

As shown in FIG. 5, this embodiment involves a terminal device, a server and a workflow execution module. The terminal device is installed with an instant messaging client, the server is used to provide services for the instant messaging client, and the workflow execution module is used to manage the menu. The terminal device establishes a communication connection with the server, and the server establishes a communication connection with the workflow execution module.

At step 501, any member of the target session can add the chatbot R as a member of the target session with the terminal device, and the terminal device transmits the message of adding the chatbot R to the workflow execution module via the server. After receiving the message, the workflow execution module can look up the online datasheet B associated with the chatbot R based on the identity of the chatbot R, obtain the configuration information of the session menu from a piece of newly created target record associated with the target session in the online datasheet B, Then, based on the configuration information of the session menu, a session menu is created for the target session. Next, the workflow execution module sends target information for instructing the output of the session menu to the terminal device via the server, and the terminal device can output the session menu in the target session based on the target information.

At step 502, after the session menu is created in the target session, any member of the target session can modify the configuration information of the session menu through a terminal device. The terminal device can transmit a request to modify the configuration information of the session menu to the workflow execution module via the server, and the workflow execution module updates the session menu based on the request to modify the configuration information of the session menu.

At step 503, if any member of the target session deletes the chatbot R from the target session by the terminal device, the terminal device can transmit the message of deleting the chatbot R to the workflow execution module through the server. The workflow execution module deletes the session menu created for the target session based on the message of deleting the chatbot R.

Corresponding to the aforementioned embodiments of method for session menu processing, embodiments of the present disclosure also provide an apparatus for session menu processing.

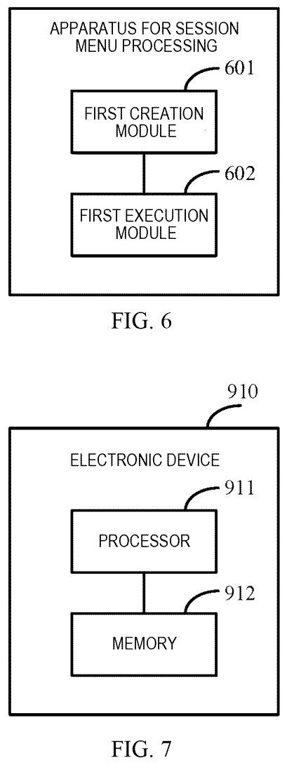

FIG. 6 is a block diagram of an apparatus for session menu processing according to an example embodiment. The apparatus may comprise a first creation module 601 and a first execution module 602.

The first creation module 601 is configured to create a session menu in the target session in response to a predetermined operation triggered by the first user on the user interface of the target session.

The first execution module 602 is configured to perform an execution step corresponding to the session menu in response to the second user's triggering operation on the created session menu. The first user and the second user are both session members of the target session, and the second user and the first user are different users or the same user.

In some embodiments, the above predetermined operation may comprise: adding a predetermined application to the target session, and the predetermined application is associated with the session menu. Alternatively, trigger a predetermined control in the target session that is associated with the session menu.

In other embodiments, if the above predetermined operation comprises adding a predetermined application to the target session and the predetermined application is a predetermined chatbot, adding the predetermined application to the target session comprises adding the predetermined chatbot as a member of the target session.

In other embodiments, the apparatus may further comprise a deletion module (not shown) configured to delete the session menu in the target session in response to an operation of removing the predetermined chatbot from the target session.

In other embodiments, the above-mentioned predetermined operation has corresponding objects, and different corresponding objects correspond to different session menus. If the above-mentioned predetermined operation corresponds to the first object, the first creation module 601 creates a first session menu corresponding to the first object in the target session. If the above predetermined operation corresponds to the second object, the first creation module 601 creates a second session menu corresponding to the second object in the target session.

In other implementations, the first creation module 601 is configured to obtain configuration information of the session menu and to create a session menu in the target session according to the configuration information.

In other implementations, the apparatus may further comprise an update module (not shown) configured to, in response to a determination that the configuration information is modified, update the session menu in the target session with the modified configuration information.

In other embodiments, the configuration information is stored in an online datasheet, and the online datasheet is associated with the corresponding object of the predetermined operation.

In other embodiments, the apparatus may further comprise a setting module (not shown) configured to set at least one configuration item in the configuration information corresponding to the session menu in response to a configuration operation by the first user.

In other embodiments, the setting module is configured to set at least one configuration item in the configuration information corresponding to the session menu with a pre-created configuration record corresponding to the target session in an online datasheet.

In other embodiments, the configuration operation of the first user is an operation triggered by the first user in the target session for the created session menu.

In other embodiments, the apparatus may further comprise a second creation module and a second execution module (not shown).

The second creation module is configured to, in response to a third user adding the predetermined chatbot as a member of a further session, create a session menu in the further session, the further session being a session other than the target session.

The second execution module is configured to, in response to a triggering operation by a fourth user on the created session menu, perform an execution step corresponding to the session menu, wherein the third and fourth users are both session members of the further session, the third and fourth users are different or same. The session menu created in the further session being different from the menu created in the target session.

In other embodiments, the above-mentioned predetermined operation has a corresponding object, and the corresponding object is associated with a first information set. The first information set includes correspondences between a plurality of sessions and a plurality of pieces of session menu configuration information. The apparatus may also comprise a third creation module (not shown) configured to, in response to the predetermined operation being triggered in a user interface of any of the plurality of sessions, determine the first information set according to the corresponding object of the predetermined operation, and to create a session menu in that session according to the session menu configuration information corresponding to that session in the first information set.

The embodiments of the apparatus basically correspond to embodiments of the method, and reference can be made to the description of method embodiments. The embodiments of apparatus as described above are only illustrative, in which the units described as separate components may or may not be physically separated. The components shown as units may or may not be physical units, that is, they may be located in a place, or can be distributed across multiple network units. Some or all of the modules can be selected according to actual needs to achieve the purpose of the disclosed embodiments solution. Persons of ordinary skill in the art can understand and implement the method without any creative effort.

FIG. 7 is a schematic block diagram of an electronic device provided by some embodiments of the present disclosure. As shown in FIG. 7, the electronic device 910 includes a processor 911 and a memory 912, which can be used to implement a client or a server. Memory 912 is used to store non-transitory computer-executable instructions (e.g., one or more computer program modules). The processor 911 is configured to run the computer executable instructions. When the computer executable instructions are run by the processor 911, the computer executable instructions can execute one or more steps in the session menu processing method described above, thereby realizing the above-mentioned steps. How to handle session menus. Memory 912 and processor 911 may be interconnected by a bus system and/or other forms of connection mechanisms (not shown).

For example, the processor 911 may be a central processing unit (CPU), a graphics processing unit (GPU), or other forms of processing units with data processing capabilities and/or program execution capabilities. For example, the central processing unit (CPU) may be of X86 or ARM architecture. The processor 911 may be a general-purpose processor or a special-purpose processor and may control other components in the electronic device 910 to perform desired functions.

For example, memory 912 may include any combination of one or more computer program products, which may include various forms of computer-readable storage media, such as volatile memory and/or non-volatile memory. Volatile memory may include, for example, random access memory (RAM) and/or cache memory (cache), etc. Non-volatile memory may include, for example, read-only memory (ROM), hard disk, erasable programmable read-only memory (EPROM), portable compact disk read-only memory (CD-ROM), USB memory, flash memory, and the like. One or more computer program modules may be stored on a computer-readable storage medium, and the processor 911 may run one or more computer program modules to implement various functions of the electronic device 910. Various application programs and various data, as well as various data used and/or generated by the application programs, etc. can also be stored in the computer-readable storage medium.

It should be noted that in the embodiments of the present disclosure, the specific functions and technical effects of the electronic device 910 can be referred to the above description of the session menu processing method, and will not be described again here.

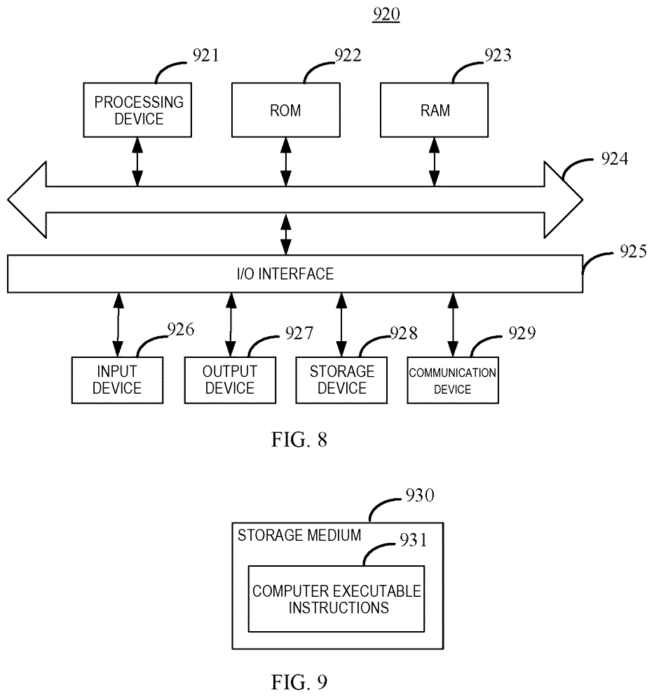

FIG. 8 is a schematic block diagram of another electronic device provided by some embodiments of the present disclosure. The electronic device 920 is, for example, suitable for implementing the session menu processing method provided by embodiments of the present disclosure. The electronic device 920 may be a terminal device or the like, and may be used to implement a client or a server. The electronic device 920 may include, but is not limited to, a mobile phone, a notebook computer, a digital broadcast receiver, a PDA (personal digital assistant), a PAD (tablet computer), a PMP (portable multimedia player), a vehicle-mounted terminal (such as a vehicle-mounted navigation terminal), Mobile terminals such as wearable electronic devices and fixed terminals such as digital TVs, desktop computers, smart home devices, etc. It should be noted that the electronic device 920 shown in FIG. 8 is only an example, which does not bring any limitations to the functions and usage scope of the embodiments of the present disclosure.

As shown in FIG. 8, the electronic device 920 may include a processing device (such as a central processing unit, a graphics processor, etc.) 921, which may be loaded into a random access program according to a program stored in a read-only memory (ROM) 922 or from a storage device 928. The program in the memory (RAM) 923 executes various appropriate actions and processes. In the RAM 923, various programs and data required for the operation of the electronic device 920 are also stored. The processing device 921, ROM 922 and RAM 923 are connected to each other through a bus 924. An input/output (I/O) interface 925 is also connected to bus 924.

Generally, the following devices may be connected to the I/O interface 925: input devices 926 including, for example, a touch screen, touch pad, keyboard, mouse, camera, microphone, accelerometer, gyroscope, etc.; including, for example, a liquid crystal display (LCD), speakers, vibration An output device 927 such as a computer; a storage device 928 including a magnetic tape, a hard disk, etc.; and a communication device 929. The communication device 929 may allow the electronic device 920 to communicate in a wireless or wired manner with other electronic devices to exchange data. Although FIG. 8 illustrates electronic device 920 having various means, it should be understood that implementation or provision of all illustrated means is not required and electronic device 920 may alternatively implement or be provided with more or fewer means.

For example, according to embodiments of the present disclosure, the above-mentioned processing method of the session menu can be implemented as a computer software program. For example, embodiments of the present disclosure include a computer program product, which includes a computer program carried on a non-transitory computer-readable medium, and the computer program includes program code for executing the above-mentioned processing method of the session menu. In such embodiments, the computer program may be downloaded and installed from the network via communication device 929, or from storage device 928, or from ROM 922. When the computer program is executed by the processing device 921, the functions defined in the session menu processing method provided by embodiments of the present disclosure can be realized.

FIG. 9 is a schematic diagram of a storage medium provided by some embodiments of the present disclosure. For example, as shown in FIG. 9, the storage medium 930 may be a non-transitory computer-readable storage medium for storing non-transitory computer-executable instructions 931. When the non-transitory computer-executable instructions 931 are executed by the processor, the processing method of the session menu described in the embodiments of the present disclosure may be implemented. For example, when the non-transitory computer-executable instructions 931 are executed by the processor, the method according to the above may be executed. One or more steps in the session menu processing method.

For example, the storage medium 930 may be applied in the above-mentioned electronic device. For example, the storage medium 930 may include a memory in the electronic device.

For example, the storage medium may include a memory card of a smartphone, a storage component of a tablet computer, a hard drive of a personal computer, random access memory (RAM), read only memory (ROM), erasable programmable read only memory (EPROM), Portable compact disk read-only memory (CD-ROM), flash memory, or any combination of the above storage media can also be other suitable storage media.

For example, the description of the storage medium 930 may refer to the description of the memory in the embodiments of the electronic device, and repeated descriptions will not be repeated. For the specific functions and technical effects of the storage medium 930, please refer to the above description of the session menu processing method, which will not be described again here.

It should be noted that in the context of the present disclosure, a computer-readable medium may be a tangible medium that may contain or be stored for use by or in conjunction with an instruction execution system, apparatus, or device. program. The computer-readable medium may be a computer-readable signal medium or a computer-readable storage medium or any combination of the two. The computer-readable storage medium may be, for example, but is not limited to: an electronic, magnetic, optical, electromagnetic, infrared, or semiconductor system, device or device, or any combination thereof. More specific examples of computer readable storage media may include, but are not limited to: an electrical connection having one or more wires, a portable computer disk, a hard drive, random access memory (RAM), read only memory (ROM), removable Programmed read-only memory (EPROM or flash memory), fiber optics, portable compact disk read-only memory (CD-ROM), optical storage device, magnetic storage device, or any suitable combination of the above. In this disclosure, a computer-readable storage medium may be any tangible medium that contains or stores a program for use by or in connection with an instruction execution system, apparatus, or device. In the present disclosure, a computer-readable signal medium may include a data signal propagated in baseband or as part of a carrier wave, carrying computer-readable program code therein. Such propagated data signals may take many forms, including but not limited to electromagnetic signals, optical signals, or any suitable combination of the above. A computer-readable signal medium may also be any computer-readable medium other than a computer-readable storage medium that can send, propagate, or transmit a program for use by or in connection with an instruction execution system, apparatus, or device. Program code embodied on a computer-readable medium may be transmitted using any suitable medium, including but not limited to: wire, optical cable, RF (radio frequency), etc., or any suitable combination of the above.

Other embodiments of the disclosure will be readily apparent to those skilled in the art from consideration of the specification and practice of the invention disclosed herein. The present disclosure is intended to cover any variations, uses, or adaptations of the disclosure that follow the general principles of the disclosure and include common knowledge or customary technical means in this FIELD that are not disclosed in the disclosure. The specification and embodiments are considered to be illustrative only, with the true scope and spirit of the disclosure being indicated by the claims.

It is to be understood that the present disclosure is not limited to the precise structures described above and illustrated in the accompanying drawings, and various modifications and changes may be made without departing from the scope thereof. The scope of the disclosure is limited only by the appended claims.

I/We claim:

1. A method for session menu processing, comprising:
in response to a predetermined operation triggered by a first user on a user interface of a target session, creating a session menu in the target session; and
in response to a triggering operation on the created session menu by the second user, performing an execution step corresponding to the session menu,
wherein the first and second users are both session members of the target session, and the second user and the first user are different users or the same user.

2. The method of claim 1, wherein the predetermined operation comprises:
adding a predetermined application to the target session, the predetermined application associated with the session menu; or
triggering a predetermined control in the target session, the predetermined control associated with the session menu.

3. The method of claim 2, wherein in response to the predetermined operation comprising adding a predetermined application to the target session,
the predetermined application is a predetermined chatbot; and
the adding a predetermined application to the target session comprises adding the predetermined chatbot as a member of the target session.

4. The method of claim 3, wherein after creating the session menu, the method further comprises:
in response to removing the predetermined chatbot from the target session, deleting the session menu from the target session.

5. The method of claim 1, wherein the predetermined operation has a corresponding object, and different corresponding objects correspond to different session menus,
in response to the predetermined operation corresponding to a first object, a first session menu corresponding to the first object is created in the target session; and
in response to the predetermined operation corresponding to the second object, a second session menu corresponding to the second object is created in the target session.

6. The method of claim 1, wherein creating a session menu in the target session comprises:
obtaining the configuration information of the session menu; and
creating the session menu in the target session according to the configuration information.

7. The method of claim 6, further comprising:
in response to a determination that the configuration information is modified, updating the session menu in the target session with the modified configuration information.

8. The method of claim 6, wherein the configuration information is stored in an online datasheet associated with the corresponding object of the predetermined operation.

9. The method of claim 6, wherein after creating the session menu, the method further comprises:
in response to a configuration operation by the first user, setting at least one configuration item in the configuration information corresponding to the session menu.

10. The method of claim 9, wherein setting at least one configuration item in the configuration information corresponding to the session menu comprises:
setting at least one configuration item in the configuration information corresponding to the session menu with a pre-created configuration record corresponding to the target session in an online datasheet.

11. The method of claim 9, wherein the configuration operation by the first user is an operation triggered by the first user for the created session menu in the target session.

12. The method of claim 3, further comprising:
in response to a third user adding the predetermined chatbot as a member of a further session, creating a session menu in the further session, the further session being a session other than the target session; and
in response to a triggering operation by a fourth user on the created session menu, performing an execution step corresponding to the session menu, wherein the third and fourth users are both session members of the further session, the third and fourth users are different or same,
the session menu created in the further session being different from the menu created in the target session.

13. The method of claim 1, wherein the predetermined operation has a corresponding object, the corresponding object associated with a first information set, the first information set includes correspondence between a plurality of sessions and a plurality of pieces of session menu configuration information;
wherein the method further comprises:
in response to the predetermined operation being triggered in a user interface of any of the plurality of sessions, determining the first information set according to the corresponding object of the predetermined operation, and creating a session menu in that session according to the session menu configuration information corresponding to that session in the first information set.

14. A computer-readable storage medium storing a computer program thereon, the computer program, when executed in a computer, causing the computer to:
in response to a predetermined operation triggered by a first user on a user interface of a target session, create a session menu in the target session; and
in response to a triggering operation on the created session menu by the second user, perform an execution step corresponding to the session menu,
wherein the first and second users are both session members of the target session, and the second user and the first user are different users or the same user.

15. An electronic device comprising a memory and a processor, the memory storing executable code, the processor, when executing the executable code, implementing a method, the method comprising:
in response to a predetermined operation triggered by a first user on a user interface of a target session, creating a session menu in the target session; and
in response to a triggering operation on the created session menu by the second user, performing an execution step corresponding to the session menu,
wherein the first and second users are both session members of the target session, and the second user and the first user are different users or the same user.

16. The electronic device of claim 15, wherein the predetermined operation comprises:
adding a predetermined application to the target session, the predetermined application associated with the session menu; or
triggering a predetermined control in the target session, the predetermined control associated with the session menu.

17. The electronic device of claim 16, wherein in response to the predetermined operation comprising adding a predetermined application to the target session,
the predetermined application is a predetermined chatbot; and
the adding a predetermined application to the target session comprises adding the predetermined chatbot as a member of the target session.

18. The electronic device of claim 17, wherein after creating the session menu, the method further comprises:
in response to removing the predetermined chatbot from the target session, deleting the session menu from the target session.

19. The electronic device of claim 15, wherein the predetermined operation has a corresponding object, and different corresponding objects correspond to different session menus,
in response to the predetermined operation corresponding to a first object, a first session menu corresponding to the first object is created in the target session; and
in response to the predetermined operation corresponding to the second object, a second session menu corresponding to the second object is created in the target session.

20. The electronic device of claim 15, wherein creating a session menu in the target session comprises:
obtaining the configuration information of the session menu; and
creating the session menu in the target session according to the configuration information.
